(19) United States
(12) Patent Application Publication
(10) Pub. No.: US 2011/0288874 A1
(43) Pub. Date: Nov. 24, 2011

(54) System and Method for Providing Authentication of Medical Data Through Biometric Identifier

(75) Inventor: Thomas J. Hinkamp, Winnetka, IL (US)

(73) Assignee: MidAmerican Healthcare Inc., Winnetka, IL (US)

(21) Appl. No.: 12/782,375

(22) Filed: May 18, 2010

(51) Int. Cl. G06Q 10/00; G06F 21/24; G06Q 50/00

(52) U.S. Cl. 705/1.1; 726/7

(57) ABSTRACT

A terminal device is provided for accessing an animal's medical record, which is stored in part at two or more locations, in compliance with a biometric authentication protocol. When a person accesses the medical record, a biometric identifier is collected from the person and input to the terminal device. The terminal device analyzes the biometric identifier and grants access to the medical data stored thereon when the biometric identifier matches that associated with the medical record. In addition, the terminal device communicates with a remote server for accessing the medical data stored thereon. Access to the data stored on the remote server also requires the biometric authentication.

### FIELD OF THE INVENTION

This invention relates to a system for recording medical information on a terminal device using biometrics both to enter the information and essentially put a biometric tag on the information. This biometric tag on data is then utilized to access and authenticate the placement of the data inside a secondary medical database.

### BACKGROUND

One of the challenges in modern healthcare industry is that medical information of a patient can exist in multiple locations and healthcare services can be provided in difficult and different locations. For example, one might have a primary care doctor who is affiliated with a hospital. That primary care doctor may have his own medical database in his office. That medical database may not interact with the hospital's database.

Hospitals usually own and maintain their own databases, which are primarily for inpatient admissions. Many patients in a large urban area, for example, may go to multiple different hospitals for different types of procedures seeking different doctors with different expertise. Medical care services then get delivered in different hospitals and all of these hospitals have separate medical databases.

Further, a patient may have laboratory data drawn at outpatient clinics. That laboratory data usually exist in a medical database that is within or part of a company, such as the Laboratory Corporation of America. Outpatient clinics may also have their own specific databases. Government and local cities run health clinics, who have their own medical databases.

Pharmacies, such as Walgreen and CVS drug stores, now have their own separate medical databases, even if they don't have their own clinic. The pharmacies maintain their own databases of patients medications and prescriptions, which are considered to be part of the medical records. Recently large grocery chains start to sell prescription medications such as delivering H1N1 and pneumococcal vaccinations in their facilities, given by healthcare professionals. In this situation, the patient receives a paper verification, which is then lost or misplaced.

Therefore, there are a number of different types of medical data, which are distributed at different locations and maintained by different entities. One of the challenges in modern healthcare information systems is to properly integrate, identify, and share all of the medical data.

In conventional healthcare information system, there is a presumption that, after the system has verified a person based on his/her name, rank, serial number, date of birth, and other demographic information, the person providing the information is in fact the owner of the medical data or has the authority to access the data. Occasionally the registrar will ask for a picture ID for authentication purposes. This process of registration is rather informal. Therefore, the person taking the information will assume then that this information is associated with the person, who is then given access to the data.

The data, of course, may be mismanaged, may be errant or may be irregular. The data are entered and then it is presumed, of course, that this data then become part of the person's medical record. We know, of course, the account that is used to enter the data because in many information systems now there is a log for tracking the account activities. This somewhat ensures that we know who entered the data, but certainly doesn't ensure that the data itself is truly associated with the person whose data are being entering. It is therefore more desired that when the patient gets a test or a medical procedure performed by a clinics or a healthcare setting, a biometric identifier of the patient is used to identify the particular procedure and data acquired and to properly label the data.

### SUMMARY

Described herein is a method and system for providing medical record, which is maintained at least in part in two or more locations, through a terminal device such as a portable communication device or a kiosk, where a biometric authentication protocol is employed for associating the medical record with the person who possesses or has access to the terminal device.

In general, a portion of the medical record is stored locally on the terminal device and other portions are stored at remote locations. When a person tries to gain access to the medical record through the terminal device, a biometric identifier is required for the granting the access and input to the terminal device in accordance with the authentication protocol. The biometric authentication protocol insures that the medical data is not compromised by unauthorized persons or is mistaken to be the medical information of a wrong person. The biometric identifier is required to unlocked the medical record or to tag new medical data when additional medical data is input into the medical record.

The terminal device provides communications with servers at the remote location, so as to allow access to the additional data stored on the remote servers through the terminal device. In general, when a person attempts to access the remote servers through a terminal device, the biometric authentication is also required. The biometric identifier collected at the terminal device is transmitted to the remote servers, which is also protected by the biometric authentication protocol. When the person accessing the medical record requests additional data be sent to the terminal device from the remote server, the server provides the portion of the medical record in accordance with the security level associated with the biometric identifier. When new data is stored into any remote server, it is tagged with the biometric identifier.

The system allows not only the patient to access his/her own medical record by providing the biometric identifier, but also persons who are not the patient himself/herself to gain access to the medical record in accordance with the biomedical authentication protocol.

In one embodiment, the biometric authentication employs a multi-level security scheme, in which the biomedical identifier is analyzed to determined how much medical information should the person be allow to access. In another embodiment, the multi-level security scheme authenticates the person and grants different level of access to the medical record in accordance with different biometric identifiers of the same person. When the person who tries to access the medical record is not the patient, the authentication protocol allows access to the medical record in accordance with the biometric identifier collected from that person.

In some embodiments, the method includes collecting biometric information of the animal at a terminal device or through an application running on the terminal device. The biometric information includes a biometric identifier that allows it to identify the terminal device or authenticate the user. When the user or the terminal device is authenticated in accordance with the biometric identifier, the system allows the user to access the medical data, which is part of the medical record, stored thereon.

Furthermore, the system allows the user to access additional medical data, which are also part of the medical record, stored on a remote server through the terminal device. Data collected at the terminal device can be transmitted to the remote server for updating the medical data stored there. The additional medical data can be downloaded onto the terminal for viewing or further analysis.

To access the additional medical data, the remote server requires biometric authentications in additional to those performed at the terminal device. The biometric identifier collected at the terminal device is transmitted to the server, which then compares the biometric identifier with those stored at the server. If a match is found, the terminal device or the use is authenticated and the access to the additional medical record is granted.

In some alternative embodiments, a method is disclosed for providing a medical record of an animal in which the medical record is maintained at least in part in two or more locations. The method comprises collecting biometric information of an animal at a terminal device that houses at least a part of the medical record, establishing a communications link between the terminal device and a server that maintains at least a part of the medical record that complements the part of the medical record maintained at the terminal device such that a combination of the parts of the medical record maintained at the terminal device and at the server provides a copy of the medical record of the animal. The method compares the collected biometric information to biometric information maintained as part of the medical record in order to determine whether the medical record belongs to the animal providing the collected biometric information, authenticating the terminal device at the remote server, and accessing the medical record through the terminal device.

According to some alternative embodiments, a terminal device is disclosed for providing a medical record stored in part at least in two or more location, wherein at least a part of the medical record is stored in a remote server in communication with the terminal device. The terminal device includes means for collecting biometric information of an animal, means for authenticating the animal in accordance with the biometric information, a memory for storing at least a part of the medical record of the animal, wherein the part of the medical record stored in the memory complements the part of the medical record maintained at the remote server, a transceiver for communicating with the remote server, wherein the transceiver receives the part of the medical record maintained at the remote server to form a copy of the medical record with the part of medical record stored in the memory, and a user interface for accessing the medical record when the animal is authenticated.

According to still some alternative embodiments, a computer readable medium is disclosed, including computer program codes, the computer program codes, when executed by one or more digital processors, instructing the one or more digital processors to provide access to a medical record stored in part at least in two or more location, wherein at least a part of the medical record is stored in a remote server in communication with a terminal device. The computer program codes includes instructions for collecting biometric information of an animal, instructions for authenticating the animal in accordance with the biometric information, instructions for storing a portion of the medical record in a memory of the terminal device, wherein the portion of the medical record stored in the memory complements the part of the medical record maintained at the remote server, instructions for receiving the part of the medical record maintained at the remote server to form a copy of the medical record, and instructions for allowing a user to access the medical record through the terminal device.

### BRIEF DESCRIPTION OF THE DRAWINGS

FIG. 1 depicts a schematic diagram of a system for providing a medical record which is stored at least in part at one or more locations;

FIG. 2A depicts a schematic diagram of the terminal devices shown in FIG. 1;

FIG. 2B depicts the multi-level security scheme for accessing the medical data on the portable device and the remote server;

FIG. 3 depicts the database structure of the remote server;

FIG. 4A shows a user interface generated by the application on the terminal device, where the application prompts a user to input a fingerprint as the biometric identifier;

FIG. 4B shows another user interface generated by the application, where a voice sample is used as the biometric identifier; and

FIG. 5 shows a method which is implemented with the system shown in FIG. 1 for providing access to a medical record through a portable device.

### DETAILED DESCRIPTION

Many mobile devices today have software applications which allow entering of medical data, including, but not limited to, medical history, medical systems, medical findings, medical labs, medicines, physiologic parameters, DNA, RNA, and genotypes. The medical data may include age, sex, race, hair color, eye color, etc.

In one embodiment, when certain medical procedure, such as an IV, an injection, test, a drug administration, or a blood draw, is applied to a patient, the patient is identified through a terminal device based on the biometric information. In addition, the medical data taken during the medical procedure is tagged with the biometric identifier such that when it is sent to a remote location. It is again required authentication that the medical data such as the IV et al. data belong to the patient identified by the biometric information.

In this embodiment, a biometric identification process is involved in the transmission of any medical data such as radiology pictures, cardiology video clips, MRI scans, lab test results, ultrasound images, echocardiograms, etc. These data are considered to be part of the medical record, which is associated with a biometric identifier of the patient in additional to the conventional means of identifying the patient, such as, name and date of birth. The biometric tag or identifier associated each set of information allows the system to better handle information as it moves across the system or network. This is also true for a virtual private network. New medical data require biometric authentication and identification prior to entering the virtual private network.

Further in this embodiment, it is required to prove that the healthcare or medical data exists with a particular person. For example, a single fingerprint collected at the portable device can bring up the entire or a portion of the medical record associated with that fingerprint. In order to delve deeper in the authentication process, the system may require a second biometric, a third biometric, etc., which allow increasing levels of security for information as it is stored inside of a medical record.

The biometric authentication in terms of opening further levels of access or deeper levels of security may also involve opening not only additional biometrics but the conventional demographics and numbers, which allow a user of the system to better identify the patient. Simple demographics include data of birth, address, phone number, social security number, driver's license, etc. These conventional demographics can be opened up further in response to a biometric identifier. For example, if the biometric is a fingerprint, then the biometric would just the next layer of security and on that next layer of security exists a picture of the patient which would then be further authenticated by making sure that the fingerprint and the picture both belong to the same patient. Then they may open further demographics as well. So the biometric tag on data can also be used in the authentication process where further layers of biometric security and further biometric identification were opened up.

Furthermore, when the collected biometric information is sent to a remote location, which includes additional medical data of the same patient, the biometric identifier also provides authentication at the remote location, where the information can be joined with or to other medical data. Accordingly, the system provides access to a secondary database and allows updating the secondary database with the collected biometric information.

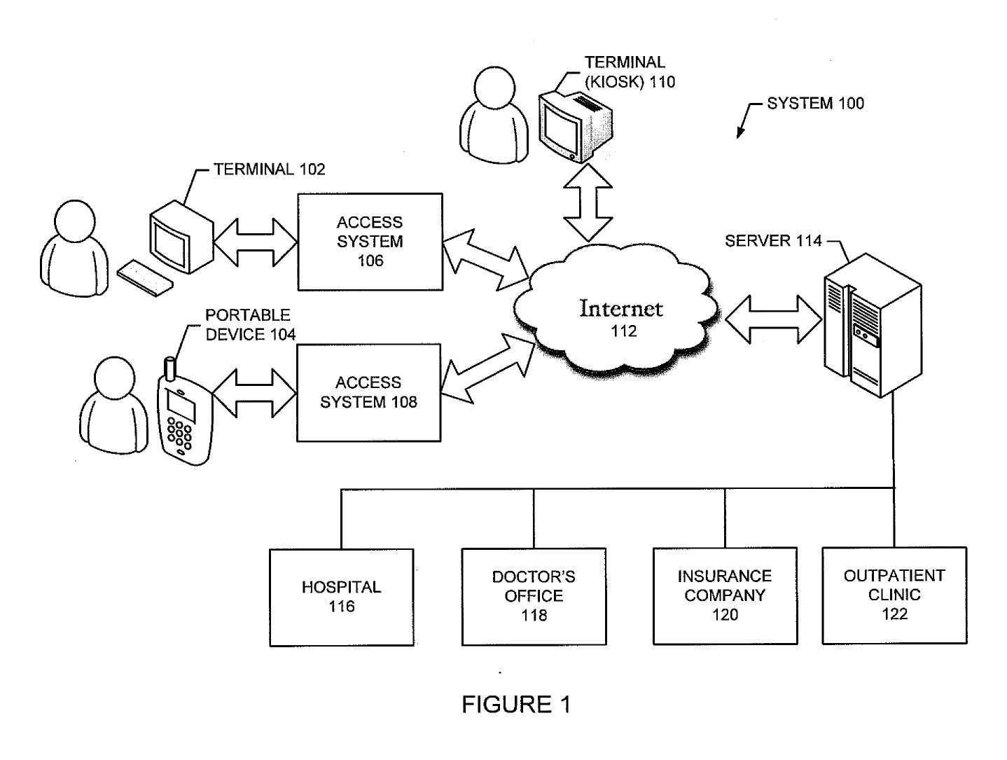

Now turning to the drawings, FIG. 1 depicts a system 100 for providing medical record which is maintained at least in part in two or more locations. For example, a part of the medical record of a patient can reside in the doctor's office 118, stored in a computer or a paper record. Another part of the medical record may exist in an insurance company 122 who keeps a record each time the patient visits his/her doctor or hospital. Still another part of the record can include all of the radiology tests that the patient has had at the outpatient clinic 122.

Hospital 116 also has at least a part of the patient's medical record. If the patient was admitted in a hospital or as an outpatient having outpatient tests within that hospital, then healthcare data have been generated there as part of the medical record.

In one embodiment, system 100 provides a portable device such as a phone 104, a portable computer 102, a radiofrequency identification device reader, a sketch book, which stores healthcare data in a program running on the portable device. The portable device can receive a biometric identifier of a patient and associate the biometric identifier with the patient's healthcare data, which are further associated with a time stamp and location stamp. The time stamp can be generated from the internal clock of the portable device or any clock signals synchronized through a wireless network or a computer network. The location stamp can be generated by a positioning system, such as GPS or cellular networks, which is embedded in or attached to the portable device.

In an alternative embodiment, the patient's healthcare data are associated with a biometric identifier of another person, such as the patient's primary doctor, the patient's family members, or a registrar at a clinic or hospital. The portable device can then receive the biometric identifier of the person who is entering the data on the portable device so that this person different from the patient can be authenticated and allowed to access the patient's healthcare data, when the patient is unable or unavailable to provide his/her own biometric identifier.

The biometric identifier of the patient whose health data are being entered is entered at the same time or at a later time. The biometric identifier can take forms of a photo of the patient, a fingerprint, a voice sample, an iris scan, a DNA sample, etc. As mentioned above, the biometric identifier of other persons related to the patient can also be entered and stored onto the portable device.

In a further embodiment, the system 100 is able to match a new biometric identifier with an old one which was previously collected and stored on the system, when the old and new biometric identifiers are collected from the same animal, even if they are not completely identical. In particular, due to factors such as aging, wounds, surgery, or environmental conditions, the new biometric identifier which is collected later may not has certain variations and is not completely identical to the old biometric identifier. The system 100 is able to match the new biometric identifier with the old one by taking into account the variations caused by these factors.

In a further embodiment, the portable device communicates with a secondary database residing on a server 114 at the remote sites, such as the hospital 116, the doctor's office 118, the insurance company 120, the outpatient clinic 122, etc. The portable device can retrieve data from the secondary databases or sends data to the secondary databases to update the data stored thereon. Biometric authentication is used to ensure the correct identification and confidentiality of the patient's data when they are exchanged between the portable device and the server. If the person entering the healthcare data is different from the patient, that person is also required to provide his/her biometric identifier along with the data. When the data are placed in a different medical system, there would be one or more biometric tags associated with the health information.

In still a further embodiment, system 100 provides a kiosk 110 in a small health center or in a phone booth like setting where a patient can walk into and provide his/her biometric information. The kiosk 110 can also collect physiologic information, laboratory data, blood work, etc. from the patient. This information is then tagged with the biometric identifier and transmitted to a separate location, where it is used to populate a secondary medical database. The kiosk 110 can further download additional information or another data set to be presented to the patient or healthcare provider at the scene. Again biometric authentication is utilized to analyze and tag the data collected at the kiosk 110.

According to the embodiments shown in FIG. 1, a biometric identifier is a piece of biometric information that uniquely identifies a patient. The biometric identifier can be a fingerprint of one or more of fingers, an iris scan or a retinal scan of one or both of eyes, a palm print, a palm vein image, a picture of a person's face, a piece of DNA or RNA sample that specifically identifies the patient, a recorded voice sample of a person, or a combination of different types of biometric information. These are mere examples, not limited of course to them, of what a biometric identifier includes. A combination of these biometric identifiers require to uniquely identify an animal.

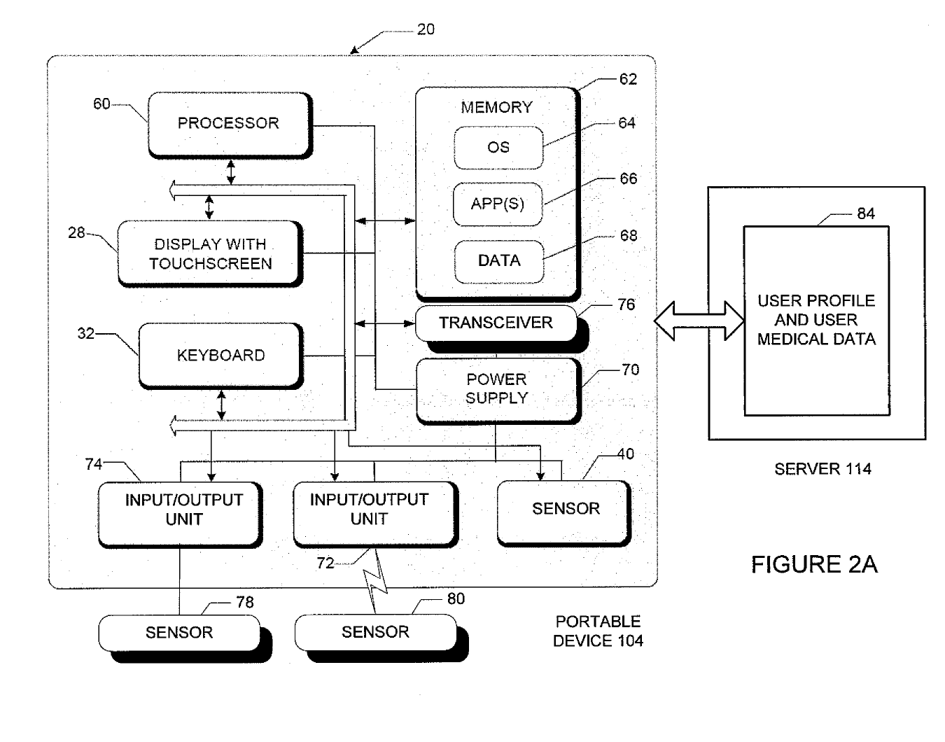

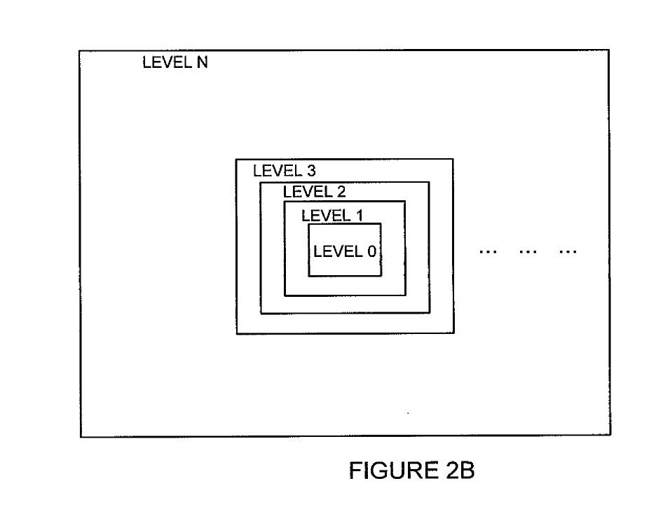

FIG. 2A depicts an embodiment of the portable device 104, which stores user profiles and users' medical data. The portable device 104 has the ability to receive data input and biometrically tag the data. The portable device 104 can also send and receive information to and from the server 114 for exchanging medical data.

In particular, the portable device 104 has a housing 20, to which various components designed to provide the functionalities described herein are attached. The components include a processor 60, a memory 62, a display 28, a keyboard 32, a transceiver 76, a power supply 70, input/output units 72 and 74, and a sensor 40.

The sensor 40 can collect medical data as well as at least one of the biometric identifiers described above. It therefore can take the form of a fingerprint sensor, a voice recorder, a blood sampler, a DNA analyzer, a urine sampler, a camera, an iris or retinal scanner, etc.

The display 28 and keyboard 32 are provided to interface with a user of the device. Specifically, the display 28 may include a touch screen which can also receive biometric data such as the fingerprint or palm print. The keyboard 32 allows the user to input medical data or commands for operating the device. In some embodiment, the keyboard 32 is a virtual keyboard such as those on iPhone or iPad, rendered on the display 28.

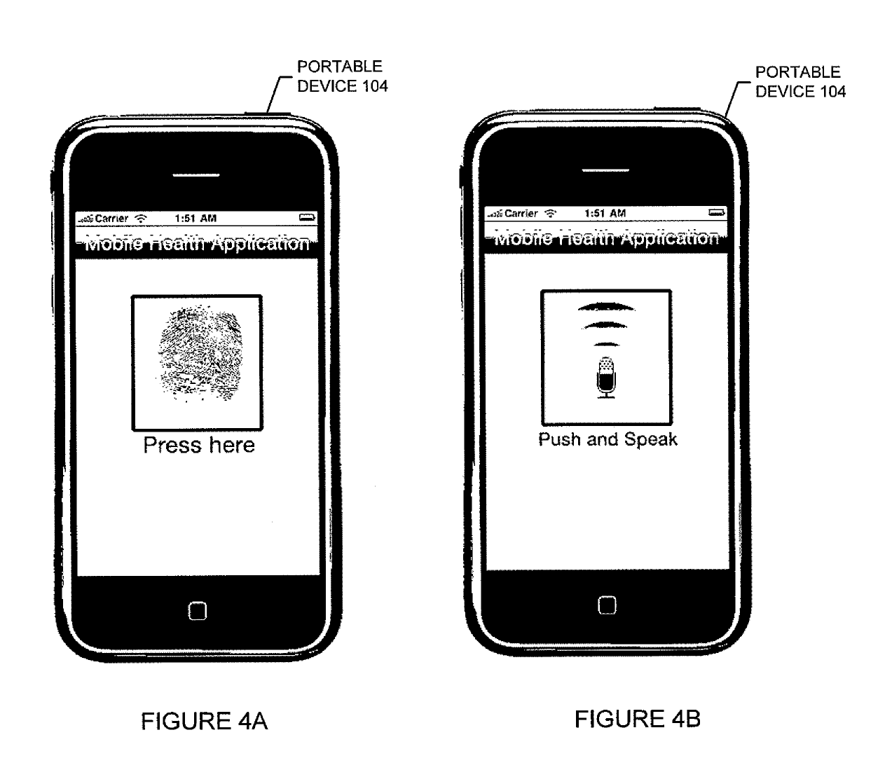

In another embodiment, the sensor 40 can be part of the display 28 or the keyboard 32. For example, FIG. 4A, shows an interface rendered on the portable device 104 which is designed to collect the user's fingerprint. Alternatively, as shown in FIG. 4B, the device 104 can also collect the user's voice sample as the biometric identifier through a micro phone embedded in the portable device.

The processor 60 together with memory 62 controls the operations of the device and provides data analysis on the medical information. Specifically, the memory 62 is divided into three parts for storing different information. The OS section 64 is used to stored computer codes of the operating system running on the device, which provide fundamental control and communication services. The operating system can be Linux, Unix, Google Android, or Microsoft Windows.

The APP section 66 contains computer codes of one or more application programs that provides the specific functionalities associated with the system 100. For example, the application programs can trigger the processor 60 to generate graphic user interface on display 28 for collecting the biometric identifier from the patient. The application programs can also apply mathematical algorithms to analyze the medical data and provide recommendations on proper medical procedures that would then be operated on the patient. The application programs can further receive user input for modifying the medical data or triggering the communication with the server 114.

The DATA section 68 stores the healthcare data and user profiles. The data are stored in a secure fashion so that the biometric authentication is required to access the data. In one embodiment, a user's healthcare data stored in the DATA section 68 are associated with a biometric identifier of the user, which is stored as an entry of his/her user profile. The data are encrypted and only become available when a match with the user's biometric identifier is detected. Specifically, when a user tries to access the healthcare data through the application, the user is prompted to provide his/her biometric identifier for authentication as exemplified in FIGS. 4A and 4B. The biometric identifier collected from the user is then used to compare with the those stored in the memory. When a match is detected, the data associated with the user profile is decrypted and provided to the user through the display 28.

The transceiver 76 provides communications with the server 114 through various communication systems such as cellular network, Ethernet, Internet, or satellite networks. When the user is authenticated through the biometric authentication, the device 104 can transmit the medical data stored thereon or collected through the sensor to the server 114, which then uses these newly received data to populate the medical record stored on the server. On the other hand, the device 104 can trigger the transceiver 76 to download additional data from the server 114, thereby allowing access to the database 84 through the portable device 104.

In still a further embodiment, the device 104 can receive biometric information or health information of a user from external sensors 78 and 80. Specifically, the device 104 has input/output units 74 and 72 for communications with the external sensors through either wired or wireless connections such as WiFi or Bluetooth. Similar to sensor 40, these external sensors can detect and obtain various biometric information and health data of the user.

In still a further embodiment, the application executed on the device 104 can provide analysis on the medical data and further provide recommendations on proposer medical procedures based on the analysis. For example, when the application detects that the blood glucose level of the user drops to a predetermined value by analyzing the blood sample, the application generates a message on the display 28 or through a micro phone, prompting the user to take an action, for example, taking medications to increase the blood glucose level, calling for help or instructions, or taking another test, etc.

In still a further embodiment, the medical data stored within the memory are encrypted in a multiple-level security structure, where the user is provided access to a portion of the medical data based on the security level associated with his/her biometric identifier. FIG. 2B shows a schematic diagram of the multi-level security encryption, where biometric authentication is used as part of the authentication process for accessing information on different security levels from level 0 to N. In general, information on lower levels is less sensitive than that on higher levels. In one particular embodiment, level 0 is accessible by anyone who possesses the portable device, whereas the highest level is only accessible by the owner of the portable device, his/her close relatives, and/or his/her primary doctors.

In a further embodiment, each security level is associated with one or more biometric identifiers. The medical data encrypted on each level become available in response to a detected biometric identifiers, to which the access is granted for the corresponding level. For example, a single fingerprint of the owner of the portable device, the owner's primary doctor, or the close relative is sufficient to enter data onto a high security level, such as level N or N−1, or to download data onto that security level. A fingerprint of a total stranger may only allow viewing of the information on level 0, but not making any changes to the medical data.

As another example, a fingerprint may allow access to an initial data set stored on level 0 and then an iris scan or a palm print to access level 1. On opening level 1, for example, a picture is required to open level 2 and then level 1. As the security level increase, more specific demographics become available to identify who the patient is.

In another embodiment, encryption may or may not required for each security level, but different levels of security are enforced to allow restricted access to the medical data in accordance with the biometric authentication.

One advantage of this scheme is that more sensitive personal information can be encrypted on higher security levels which only allow selected persons to access the information, whereas the information on lower security levels are available to more person. For example, the blood type and allergy information of the user is stored on level 0, thereby allowing any person to access the data at time of emergency such as car accident or natural disaster, where the patient or device owner require immediate medical procedure.

According to another embodiment, the portable device may store multiple user profiles and their respective medical data set. For example, the portable device may be used by a doctor or an insurance agent, who travels to multiple locations to collect patients' medical data. In this embodiment, the user of the device is granted access to every patient's data on all of the security levels upon providing his/her biometric identifier(s) as described above, whereas a patient or the patient's relatives are allowed to access only the patient's own data in accordance with the multi-level authentication scheme. The user, in this case, is allowed to act as the administrator to manage each patient's account and all of the data stored on the system.

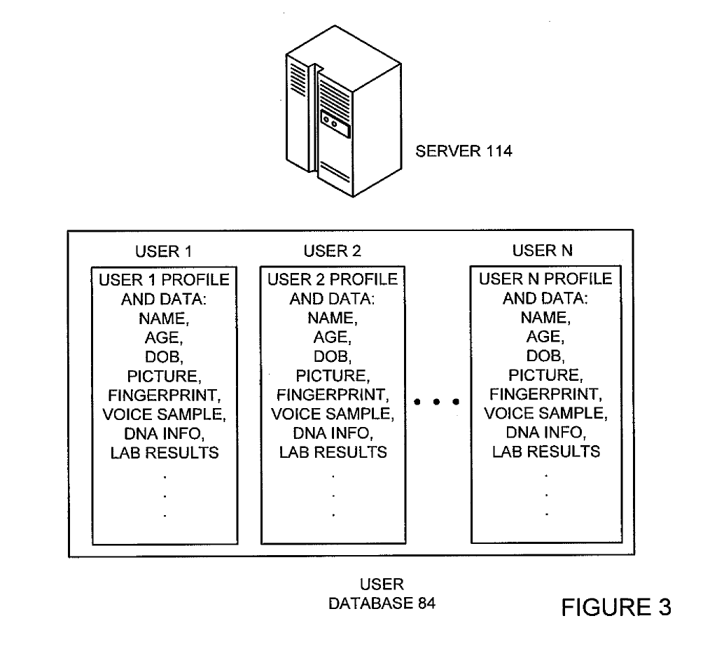

FIG. 3 depicts an example of the additional database 84 existing on the server 114, which may reside in a hospital, a doctor's office, the insurance company, or the patient's own house. The database 84 stores a plurality of patient profiles and their medical records. Each profile includes date of birth, age, name, and classic demographics of the patient. The profile further includes biometric profiles, both of the patient as well as the user. These profiles are used for authentication that grants access to the server for downloading additional medical information or updating the database 84.

Similar to the medical data stored on the portable device 104, the additional medical data on the server may also be stored in the multi-level security structure, which requires biometric authentication to access. For example, when the server 114 receives an access request from the portable device 104, the biometric identifier in the access request is examined and compared with those stored in the database 84. If a match is found for a particular user profile, the request is granted and the medical data associated with that user profile is open to download or update. The system allows multiple persons to access the same patient's medical data on different security levels, depending on the security level assigned to the biometric identifier.

FIGS. 4A and 4B depict an embodiment of the biometric authentication provided on a portable device 104, which has a healthcare information application. The device 104 can be an iTouch, an iPhone, iPad, a Blackberry, or on any sort of portable device, that allows entering healthcare information and a biometric input. As shown in FIG. 4A, the application can render an interface prompting the user to provide his/her fingerprint by pressing the screen. The application then associates the fingerprint with the healthcare data stored in the device's memory. The application can also instruct the device to send the information the server which can associate the biometric identifier with the data stored thereon. FIG. 4B depicts another interface where a voice sample is collected as the biometric identifier to tag the medical data stored on the device and/or the server. According to this embodiment, a biometric identifier (or tag) is placed on all medical data and the biometric identifier is required to process and enter the data.

According to another embodiment shown in FIGS. 4A and 4B, the application includes a process of both requiring the biometric of the person whose medical information is being entered, as well as the biometric of the person who is entering the data. For example, in an emergency situation, such as a traffic accident or an earth quake, the rescue personnel responding to the emergency can access through the portable device multiple patients' medical data on the scene of the accident by providing his/her biometric identifier, which is associated with a relative high security level so that a substantial portion of the medical data are available to the rescuer. The person entering this information can tag the information with his/her fingerprint or other biometric identifier to as well as the biometric identifier of the specific patient. This provides a mechanism to authenticate both the person who the information is coming from, as well as the person who is entering the information. This embodiment is useful for a person working for a specific organization who has his/her biometric information recorded and would be allowed by the information system to be recognized as someone who in fact enters the information.

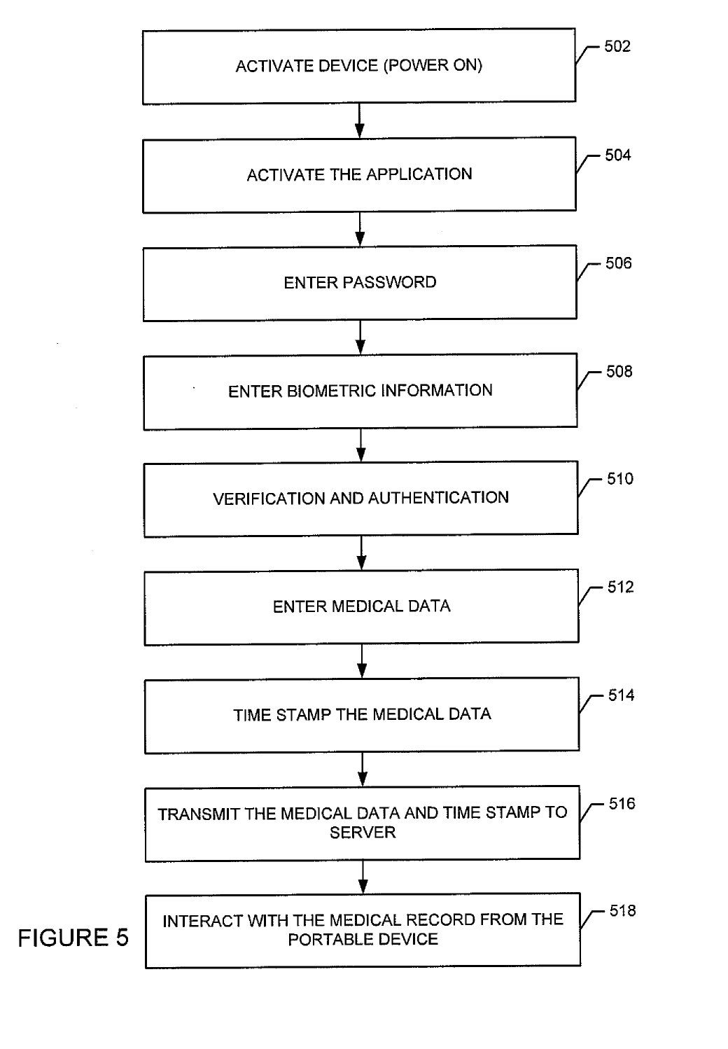

FIG. 5 depicts a method where a mobile device is used to access a medical record stored and maintained at least in part in two or more locations. Upon activating the device and the application (block 502 and 504) and entering the password (block 506), which allows entering the application, biometric information is then collected from the user who is entering the medical data (block 508). As described above, the user may or may not be the patient from whom the medical data are collected. For example, the user intends to examine five patients' healthcare information, the application then verifies the user who has just provided the biometric identifier and determines whether this user in fact is authorized to perform the operation (block 510). This biometric authentication can be perform with or without the multi-level security scheme.

Once the user is authenticated, his/her is allowed to enter medical data (block 512). This process may further involve re-authenticating the user or requiring the biometric identifier of the patient in addition to the user's be entered and associated with the medical data. The application puts a time, date, and location stamp on the medical data and the biometric information then exists as a tag for the medical data in the system (blocks 514 and 516). In 516, after the user enters the medical data, the portable device stores in its memory the data with the biometric identifier and the time and location stamp. Further, the user can instructs the portable device to transmit the medical data to another site or to another remote server. The medical data with the time, date, and location stamp and the biometric identifier are then transmitted wirelessly or through wired connections to another medical record site. In block 518, the user can also access and interact through the portable device with the medical records stored on the remote server. For example, the user can update the additional medical data on the server by sending the medical data from the local memory to the database on the remote server. Alternatively, the user can also directly modify the medical data stored on the remote server through the interface provided on the portable device. Still further, the user can download data from the remote server to the local memory for user in a medical procedure. The user can also instruct the server to transmit the medical data stored thereon to a third party such as an insurance company or a hospital. All of these interactions with the portable device and the remote server require biometric authentication as described above. This would be useful obviously to assure that the correct medical information with the correct person is appropriately stored.

These embodiments are particularly beneficial for the applications where healthcare data identified, delivered, and entered in a portable device, thereby ensuring a high level of accuracy and authenticity for the information that is being entered.

In one embodiment, the application running on the portable device and the communications can be implemented in keeping with the HL7 standard, which defines the basic elements, information flows, and program protocols in healthcare information systems and communications. According to the embodiment, the HL7 programming language as well known in the art is modified to provide the biometric authentication required in the system. Data generated in compliance with the HL7 standard are authenticated, transferred, and added to the medical database in accordance with the biometric authentication process described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for providing a medical record of an animal in which the medical record is maintained at least in part in two or more locations, the method comprising:
collecting biometric information of an animal at a terminal device that houses at least a part of the medical record, wherein the terminal device provides communications with a remote server storing another portion of the medical record;
establishing a communications link between the terminal device and a server that maintains at least a part of the medical record that complements the part of the medical record maintained at the terminal device such that a combination of the parts of the medical record maintained at the terminal device and at the server provides a copy of the medical record of the animal;
comparing the collected biometric information to biometric information maintained as part of the medical record in order to determine whether the medical record belongs to the animal providing the collected biometric information;
authenticating the terminal device at the remote server; and
accessing the medical record through the terminal device.

2. The method of claim 1, further including:
authenticating a user of the terminal device;
receiving the biometric information of the animal from user inputs of the user; and
identifying in the terminal device the part of the medical record associated with the animal; and
updating the part of the medical record stored at the terminal device to include the biometric information of the animal.

3. The method of claim 1, including:
recording date, time and location of the collected biometric information; and
adding the collected biometric information and the recorded date, time and location to the medical record.

4. The method of claim 3, including detecting the biometric information by way of one or more sensors that directly senses the animal's biometric information.

5. The method of claim 3, wherein the location is provided by at least one of a GPS system, a cellular system, and a computer network.

6. The method of claim 1, wherein the biometric information includes at least one of a voice record, a finger print, an iris scan, a DNA sample, a photo, a vital sign, a medication, a genetic characteristic, and a lab result of the animal.

7. The method of claim 1, further include:
receiving initial inputs for establishing a user profile on the terminal device; and
receiving and storing the part of the medical record in the terminal device in association with the user profile.

8. The method of claim 1, further including:
analyzing the medical record for determining a trend of health-related data of the animal; and
displaying information indicative of the trend.

9. The method of claim 1, further including:
determining a proper medical procedure for the animal in accordance with the medical record; and
displaying information indicative of the proper medical procedure to a user via the terminal device.

10. The method of claim 1, further including:
setting one or more security levels for accessing the medical data when the terminal device is authenticated; and
associating each of the one or more security levels with a priority to access a portion of the medical record.

11. The method of claim 10, further including:
assigning a password to each security level for protecting the portion of the medical record associated with the medical level.

12. A portable communication device providing a medical record stored in part at least in two or more location, wherein at least a part of the medical record is stored in a remote server in communication with the portable communication device, the portable communication device including;
means for collecting biometric information of an animal;
means for authenticating the animal in accordance with the biometric information;
a memory for storing at least a part of the medical record of the animal, wherein the part of the medical record stored in the memory complements the part of the medical record maintained at the remote server;
a transceiver for communicating with the remote server, wherein the transceiver receives the part of the medical record maintained at the remote server to form a copy of the medical record with the part of medical record stored in the memory; and
a user interface for accessing the medical record when the animal is authenticated.

13. The portable device of claim 12, wherein the transceiver further transmits the biometric information to the remote server to authenticate the portable device.

14. The portable device of claim 12, wherein the means for collecting the biometric information further includes one or more sensors for directly sensing the animal's biometric information.

15. The portable device of claim 12, wherein the means for collecting the biometric information further includes one or more communication interfaces for receiving from one or more external sensors data carrying the biometric information.

16. The portable device of claim 12, further including:
means for collecting new medical data of the animal and environmental information including at least data, time, and location associated; and
means for associating the new medical data and environmental information with the collected biometric information.

17. The portable device of claim 16, wherein the part of the medical record stored in the memory is updated to include the biometric information and the environmental information and the transceiver further transmits the biometric information, the environmental information, and the part of the medical record stored in the memory to the remote server for updating the part of the medical record maintained at the remote server.

18. A computer readable medium including computer program codes, the computer program codes, when executed by one or more digital processors, instructing the one or more digital processors to provide access to a medical record stored in part at least in two or more location, wherein at least a part of the medical record is stored in a remote server in communication with a portable communication device, the computer program codes including:
instructions for collecting biometric information of an animal;
instructions for authenticating the animal in accordance with the biometric information;
instructions for storing a portion of the medical record in a memory of the portable communication device, wherein the portion of the medical record stored in the memory complements the part of the medical record maintained at the remote server;
instructions for receiving the part of the medical record maintained at the remote server to form a copy of the medical record; and
instructions for allowing a user to access the medical record through the portable communication device.

19. The computer readable medium of claim 18, wherein the computer program codes further includes:
instructions for collecting environmental information including at least date, time and location associated with the collected biometric information;
instructions for updating the medical records to include the biomedical information and the environmental information; and
instructions for populating the medical record with new medical data authenticated by the biometric identifier.

20. The computer readable medium of claim 18, wherein the computer program codes further includes:
instructions for analyzing the medical record for determining a trend of health-related data of the animal;
instructions for displaying information indicative of the trend of health-related data;
instructions for providing recommendations of proper medical procedures to be performed on the animal in accordance with the medical record.

21. The computer readable medium of claim 18, wherein the computer program codes further includes:
instructions for sending the medical record to a health provider of the animal.
